(19) United States
(12) Patent Application Publication
(10) Pub. No.: US 2004/0239635 A1
(43) Pub. Date: Dec. 2, 2004

(54) Apparatus and method for loop-back testing in a system test/emulation environment

(76) Inventors: Ronald L. Lerner, Houston, TX (US); Lee A. Larson, Katy, TX (US)

Correspondence Address: TEXAS INSTRUMENTS INCORPORATED, P O BOX 655474, M/S 3999, DALLAS, TX, 75265

(21) Appl. No.: 10/851,533

(22) Filed: May 21, 2004

Related U.S. Application Data
(60) Provisional application No. 60/472,896, filed on May 23, 2003.

(51) Int. Cl. G09G 5/00

(52) U.S. Cl. 345/169

(57) ABSTRACT

In a test configuration in which an emulator unit is separated from a target processor under test, the effect of the emulator cable (and pod unit) on the distortion of the signals returned from the processor can be determined by a switch in which signals from the emulator unit are applied to conductor in which signals are returned to the emulator unit, the switch being located in the vicinity of the target processor. In certain test environments, addition switches can be provided proximate the target processor to isolate the emulator cable conductor signals from the target processor.

This application claims priority under 35 USC §119(e) (1) of Provisional Application Serial No. 60,472,896 (TI-35967P), filed May 23, 2003.

### 1. FIELD OF THE INVENTION

This invention relates generally to the test and emulation of a data processing unit or units and, more particularly, to the verification of signal paths coupling the test/emulation apparatus and the target processor(s).

### 2. BACKGROUND OF THE INVENTION

In the past, the testing and the debugging of electronic circuits and processing units, including digital signal processors, has been performed using an expensive on-board emulator chip or chips, or by means of a separate, off-board emulator unit. Referring to FIG. 1, a test/debug configuration for an off-board emulator unit is shown. An emulator unit 11 is coupled by means of an emulator cable 15 to a target processor 12. The emulator cable 15 typically includes a pod unit 16 and an interface unit 18. The interface unit 18 is also referred to as the header or connector. The pod unit 16 typically includes support logic necessary to retime, buffer, and/or serialize the data being exchanged between the emulator unit 11 and the target processor 12. The presence of the pod unit 16, and indeed the cable itself, can affect the exchange of signals between the emulator unit 11 and the target processor 12, thereby introducing additional variables in the test and debug procedures. These additional variables can extend the overall period of time required to perform the test and debug procedures.

Referring to FIG. 2, the configuration of FIG. 1 is shown with specific reference to a test scan function. In the test scan configuration, specific signals are present. The TMS (test mode select) signal determines the particular scan to be performed. The TDI (test data in) conductor provides a stream of digital signals that is transferred from the emulator unit 11 to a scan chain of registers in the target processor 12. The TDO (test data out) conductor transfers a stream of digital signals from the target processor 12 to emulator unit 11. A TCLK (test clock) signal is applied to the target processor by the emulator unit 11 and a TCLKRTN (test clock return) signal is transferred from the target processor 12 to the emulator unit 11. In addition, a multiplicity of other MISC (miscellaneous) conducting leads can permit the exchange of other signals.

FIG. 2 also illustrates the configuration wherein more than one target processor 12 and 12A can be tested by the emulator unit 11. In this configuration, the TDI signals and TDO signals can be transferred through the target processors in a linear series of registers, while the TMS signals and the TCLK signals are applied to the individual target processors.

In the past, the effect of the additional variables resulting from the inclusion of the cable 15 and the emulator pod unit could be ascertained by applying the test and debug procedures to a processor unit having known properties. The same test and debug procedures were then applied to the processor unit with the known properties. Any test debug results that differed from the results expected from a processor unit with known properties could then be attributed to the introduction of the cable 15 and emulator pod unit in the configuration. The results of the test and debug procedures for the target processor could then be adjusted based on the results of the tests for a processor with known attributes.

This procedure required having a processor unit with known characteristics and using the results from testing this processor to determine indirectly the effect of the cable and the emulation pod unit on the test and debug activity. However, a processor unit with known characteristics similar to the processor unit to be tested may not be available. In addition, the direct determination of the effects of the cable and the emulator pod on the test and debug procedures would be preferable to the indirect determination of these effects.

A need has therefore been for apparatus and an associated method having the feature that a target processor can be tested by an off-chip emulator unit. It would be a further feature of the apparatus and associated method to test a target processor by means of an off-board emulator unit without requiring a processor having known characteristics. It would be a still further feature of the apparatus and associated method to identify the effects of the apparatus connecting a target processor with an emulator unit on the test and debug signals exchanged there between. It would be a more particular feature of the present invention to be able to isolate electrically an emulator unit and signal transfer apparatus from a target processor. It would be yet another particular feature of the present invention to provide a loop-back path for signals that are transferred to and from a target processor without being introduced into the target processing unit.

### SUMMARY OF THE INVENTION

The aforementioned and other features are accomplished by the present invention by providing a loop-back path for signals from the emulation unit. The loop-back path, controllable by the emulation unit, provides a circuit by which signals forwarded to a target processor are returned from the target processor without being entered therein. According to the preferred embodiment, switches in the vicinity of the target processor provide a loop-back path by which the signals propagated by the test unit are returned to the test unit without being entered in the target processor. The target processor can either be instructed to ignore the signals entered therein in this mode of operational test, or switches can be provided that isolate the conductors over which the test signals are transmitted, from the target processor. This technique finds particular application in scan control signals. In this manner, the distorting effects of the emulator cable (and associated pod unit) can be separated from distorting effects of the target processor.

Other features and advantages of the present invention will be more clearly understood upon reading of the following description and the accompanying drawings and claims.

### BRIEF DESCRIPTION OF THE DRAWINGS

FIG. 1 is a block diagram of a test/emulation system according to the prior art.

FIG. 2 is a block diagram of a test/emulation system with specific reference to scan control signals according to the prior art.

FIG. 3 is a block diagram illustrating one embodiment of the loop-back apparatus of the present invention.

FIG. 4 is a block diagram illustrating a second embodiment of the loop-back apparatus present invention.

FIG. 5 illustrates the implementation of the switches of FIG. 3 and FIG. 4 according to the present invention.

### DESCRIPTION OF THE PREFERRED EMBODIMENT

### 1. DETAILED DESCRIPTION OF THE DRAWINGS

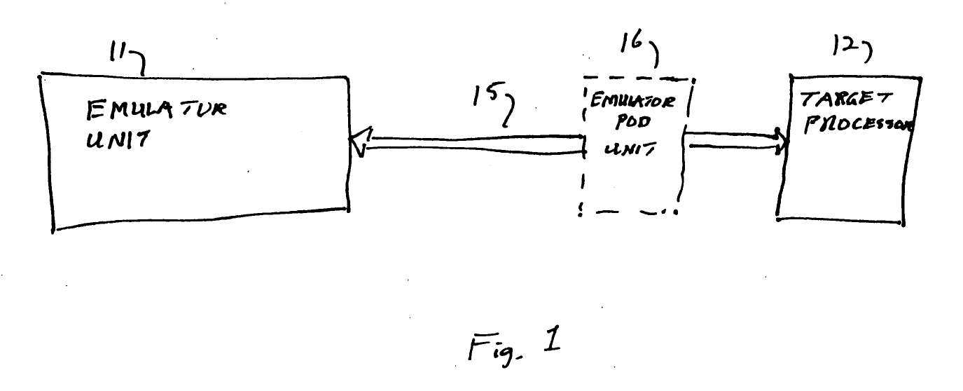

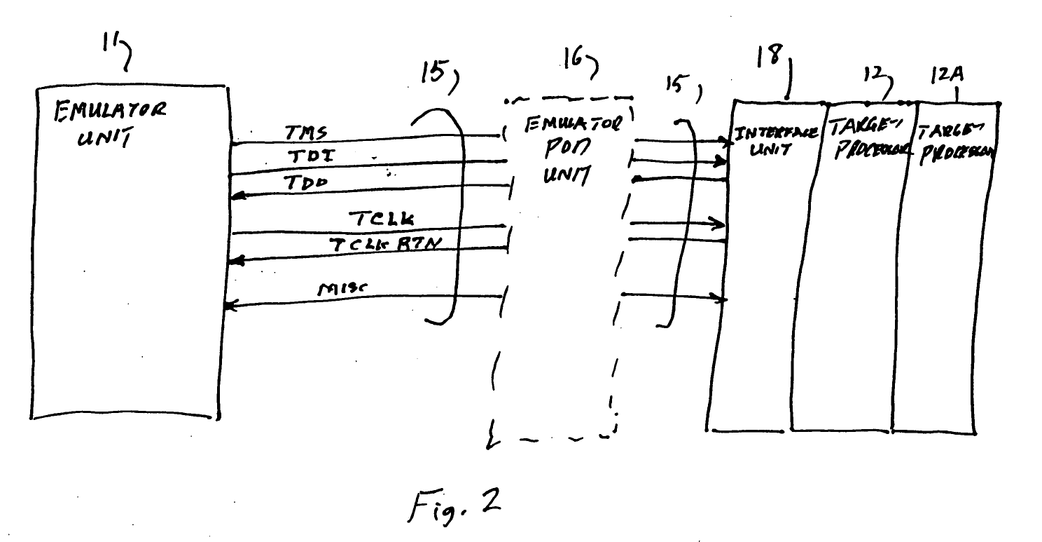

FIG. 1 and FIG. 2 have been described with respect to the related art.

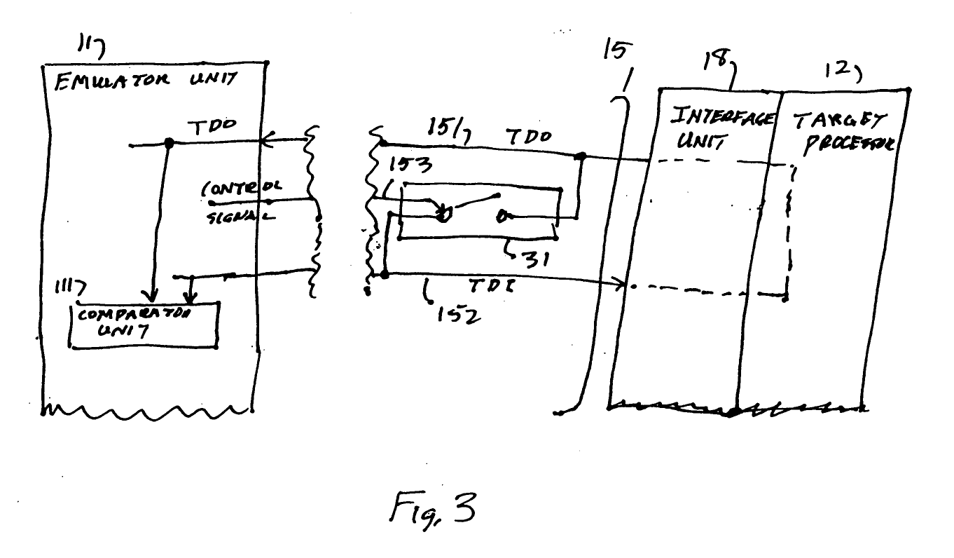

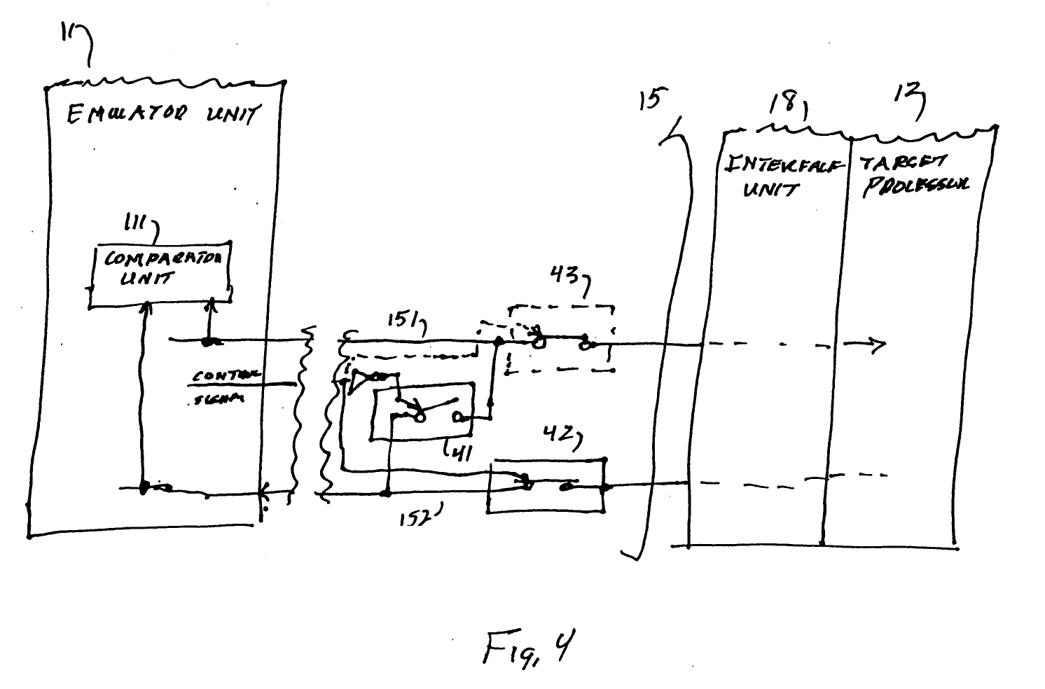

Referring to FIG. 3, a first embodiment of the loop-back apparatus of the present invention is illustrated. In normal operation, the emulator unit 11 applies signals to the TDI conductor of the emulator cable 152, the TDI signal being applied to the interface unit 18 and subsequently to the target processor 12. In response to the TDI signals, TDO signals are generated by the target processor 12 and applied through the interface unit and the conductor 151 to the emulator unit 11. The emulator unit 11, knowing the TDI signals, then compares these signals to the TDO signals and analyzes the operation of the target processor. To determine the effect of the emulator cable 15 on the transmission of the TDO and TDI signals in the absence of the operation of the target processor(s), a control signal is applied to switch 31. The switch couples the TDO conductor and the TDI conductor. As result, the TDI signals are returned as the TDO signals without the intervention of the target processor 12. The switch 31 is proximate the interface unit 18 and can be included as part of the interface unit 18. The TDO signals, actually the returned TDI signals, are then compared with the originally transmitted TDI signals. As a result of this comparison, the changes in the signals that are the result of transmission over the cable can be separated from other signal changes that result in the target processor 12.

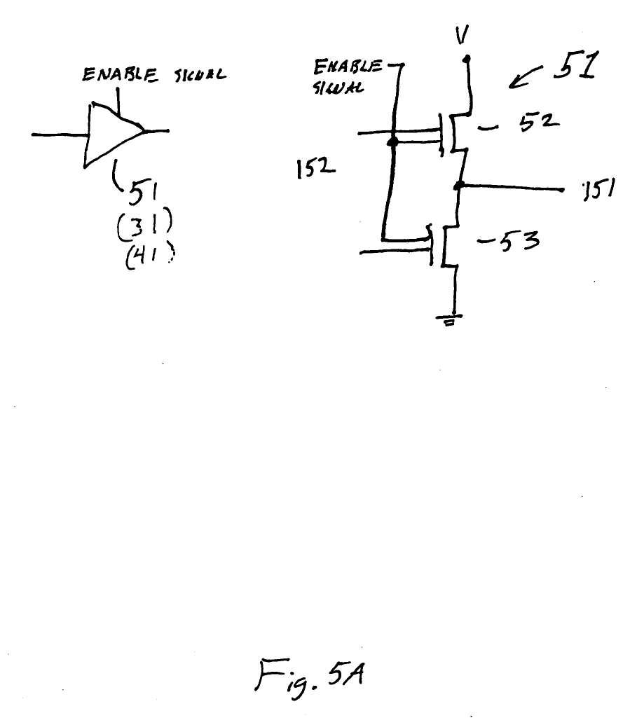

Referring to FIG. 4, a second embodiment of the present invention is shown. In this embodiment, the emulation unit 11 applies a TCLK signal to conductor 155 and the emulator unit 11 receives the TCLKRTN signal from the target processor(s) by conductor 154. A switch 41, similar to the switch 31 in FIG. 3, couples conductor 155 and conductor 154 in response to a control signal. In addition, the control signal opens the normally closed switch 42. Switches 41 and 42 have the same implementation, so inverter 44 is added to provide complementary control signals to the control terminals of switches 41 and 42. Note that switch 42 insures that no signals from the target processor are intermingled with the TCLKRTN (returned TCLK) signals. The returned TCLK signal is then applied to comparator 111. In this manner, the effect of the emulator unit (and pod unit, if present) can be separated from the effects resulting from the interaction of the TCLK signal with the target processor. In addition, switch 43, shown with dotted lines in FIG. 4 can be added to insure that the TCLK signals are not applied to the target processor 12.

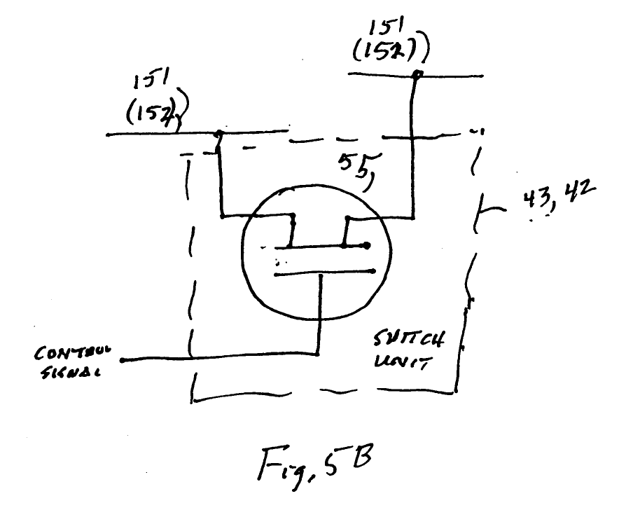

Referring to FIG. 5, the implementation of the switch 31 according to the preferred embodiment of the present invention is shown. The switch 31 is implemented with a field effect transistor 51. The gate of the field effect transistor receives the control signal. When the control signal causes the field effect transistor to be conducting, then the signal on TDI conductor 152 is applied to TDO conductor 151. The switches 41, 42 and 43 of FIG. 3 can be implemented in a similar manner.

### 2. OPERATION OF THE PREFERRED EMBODIMENT

The purpose of the present invention is to separate the effects of the emulator cable (including an emulator pod) on the transmission of signals from the emulator unit to the target processor from the effects of the emulator cable (and emulator pod) and target processor. This separation is accomplished by providing a switch, proximate to the interface unit (i.e., connector), that applies signals on a conductor originating in the emulator unit to a conductor that returns signals to the emulator unit. In other words, a loop back path is provided for the signals originating in the emulator unit. In addition, switches can be included proximate to the interface unit that electrically isolates the conductor from the interface unit. As will be clear, the switches can be included in the interface unit to provide mechanical protection for the switches.

The comparator of FIG. 3 and FIG. 4 is typically part of the processing apparatus of the emulator unit and is indicated separately here to emphasize the function of analyzing the loop-back signals.

While the invention has been described with respect to the embodiments set forth above, the invention is not necessarily limited to these embodiments. Accordingly, other embodiment variations, and improvements not described herein, are not necessarily excluded from the scope of the invention, the scope of the invention being defined by the following claims.

What is claimed is:

1. In an emulator cable, the emulator cable coupled between an emulator unit and an interface unit of the target processor, the cable comprising:
for selected conductor pairs, a switch responsive to a control signal for electrically coupling the selected conductors, the switch being proximate the target processor, the switch providing a loop-back path for signals from the emulator unit to be returned to the emulator unit.

2. The cable as recited in claim 1 further comprising a second switch proximate to the target processor and responsive to the control signal, the second switch isolating the emulator unit from signals from the target processor.

3. The cable as recited in claim 2 further comprising a third switch proximate to the target processor, the third switch isolating the target processor from the emulator unit.

4. The cable as recited in claim 1 wherein the switch is implemented with a field effect transistor.

5. The cable as recited in claim 1 wherein the selected conductor pair transmits the TDI signals and the TDO signals.

6. The cable as recited in claim 1 wherein the selected conductor pair transmits the TCLK signal and the TCLKRTN signal.

7. A method for determining the effects of emulator cable on the test/debug procedures, the method comprising:
coupling a switch between a preselected conductor pair of the emulator cable proximate the target processor;
closing the switch in response to a control signal;
in the emulator unit, applying predetermined signals to a first conductor of the preselected conductor pair; and
in the emulator unit, comparing the signals on the second conductor of the preselected conductor pair to the predetermined signals applied to the first conductor of the preselected conductor pair.

8. The method as recited in claim 7 further comprising opening a second switch proximate the target processor in response to a control signal, the open second switch isolating signals originating in the target processor from one of the conductors of the preselected conductor pair.

9. The method as recited in claim 8 further comprising opening a third switch proximate the target processor in response to the control signal, the open third switch isolating signals on a second of the conductors of the preselected conductor pair from the target processor.

10. The method as recited in claim 7 further comprising implementing the switch with a field effect transistor.

11. The method as recited in claim 7 wherein the preselected conductor pair transmits the TDI signals and the TDO signals.

12. The method as recited in claim 7 wherein the preselected conductor pair transmits the TCLK signals and the TCLKRTN signals.

13. A system for testing the effect of the transmission of the data between an emulator unit and a target processor in the test and debug procedures, the system comprising:
an emulator cable coupling the emulator unit and the target processor;
a switch coupled between a first and a second conductor of the emulator cable, the switch located proximate the target processor, the switch assuming a conducting configuration in response to a control signal; and
a comparison unit for comparing output signals applied to the first conductor by the emulation unit and input signals received by the emulation unit from the second conductor, wherein the comparison unit provides the comparison of the input signals and the output signals in response to the control signal.

14. The system as recited in claim 13 further comprising a second switch coupled between portions of the second conductor proximate to the target processor, the second switch isolating the target processor from signals on the second conductor in response to the control signal.

15. The system as recited in claim 14 further comprising a third switch coupled between portions of the first conductor proximate to the target processor, the third switch isolating signals on the first conductor from the target processor in response to the control signal.

16. The system as recited in claim 13 wherein the switch is implemented with a field effect transistor.

17. The system as recited in claim 14 wherein the first conductor transmits the TDI signals and the second conductor transmits the TDO signals.

18. The system as recited in claim 13 wherein the first conductor transmits the TCLK signal and the second conductor transmits the TCLKRTN signal.
